(19) United States
(12) Patent Application Publication
(10) Pub. No.: US 2008/0084924 A1
(43) Pub. Date: Apr. 10, 2008

(54) MATCHING PURSUITS BASIS SELECTION DESIGN

(76) Inventor: Donald Martin Monro, Beckington (GB)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 11/539,165

(22) Filed: Oct. 5, 2006

(51) Int. Cl. H04B 1/66

(52) U.S. Cl. 375/240

(57) ABSTRACT

Briefly, in accordance with one embodiment, a method of designing a basis selection for matching pursuits is described

### FIELD

This application pertains to the field of coding data, and more particularly, to the field of selection of bases for coding data using transforms and/or matching pursuits.

### BACKGROUND

Digital data for various forms of content, such as, without limitation, digital images, digital video, and/or audio information, is delivered today via wireless transmission networks, digital satellite services, streaming video and/or audio over the Internet and more. For example, again, without limitation, delivering video and/or audio content in a digital data form to personal digital assistants, cellular phones and/or other devices is continuing to increase in popularity. Therefore, a need continues for data compression and decompression techniques to allow efficient transmission and storage of digital data, regardless of the content the data represents.

### BRIEF DESCRIPTION OF THE DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a schematic diagram illustrating an embodiment of a Discrete Wavelet Transform (DWT);

FIG. 2 is a plot illustrating basis picking results for a particular data rate; and

FIGS. 3 and 4 are tables of example bases provided for illustration purposes.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, well-known methods, procedures, components and/or circuits have not been described in detail.

Some portions of the detailed description which follow are presented in terms of algorithms and/or symbolic representations of operations on data bits and/or binary digital signals stored within a computing system, such as within a computer and/or computing system memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing may involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's processors, memories, registers, and/or other information storage, transmission, and/or display devices.

Matching pursuits processes may be used to compress one dimensional or multi-dimensional data, including but not limited to: still images, audio, video, and/or digital images. A matching pursuits process may include finding a full inner product between a signal to be coded and members of a dictionary of basis functions. At a position of an inner product, a dictionary entry giving an inner product may describe the signal locally. This may be the maximum inner product over all or part of the signal. This may be referred to as an “Atom.” Amplitude may be quantized, and position, quantized amplitude, sign, and dictionary number may be combined to form a code describing a particular Atom, for example. For one embodiment, quantization may be performed using a precision limited quantization method. Other embodiments may use other quantization techniques. Claimed subject matter is not limited in scope to any particular quantization method or technique. All potential quantization methods now known or to be developed are intended to be included.

In one particular embodiment, an Atom is subtracted from a signal giving a residual. The signal may be completely and/or partially described by the Atom plus the residual. The process may be repeated with new Atoms successively found and subtracted from the residual. At any stage, the signal may be completely described by the codes of the Atoms found and the remaining residual.

Matching pursuits (MP), therefore, may decompose any signal f into a linear expansion of waveforms that may belong to a redundant dictionary D=φ{γ} of basis functions, such that

$$f = {{\sum }_{n = 0}}^{m - 1} {α}_{n} {ϕ}_{{γ}_{n}} + {R}^{m} f$$

where R^{m} f is the m^{th} order residual vector after approximating f by m ‘Atoms’ and

αₙ=[φ_{γ}_{ₙ}, Rⁿf]

is an inner product at stage n of a dictionary with an nth order residual, for this particular embodiment.

For some embodiments, a dictionary of basis functions may comprise two-dimensional bases. Other embodiments may use dictionaries comprising one-dimensional bases which may be applied separably to form two-dimensional bases. To do this, a selected basis function may be applied to a set of data in one of its dimensions and another basis function may subsequently be applied in another dimension, the remaining dimension if there are two dimensions. A dictionary of b basis functions in one dimension may provide b² combinations which form a dictionary of b² basis functions in two dimensions, for example. This may likewise be extended to any number of dimensions. Therefore, in this context, the term “separably” includes applying different basis functions to data separately.

As described in more detail hereinafter, a method is described which may reduce complexity of a codebook to be applied to coding of multi-dimensional data. Likewise, improved representation of the data may also at times occur. In this particular embodiment, a dictionary of n dimensional bases may be formed separably, as described above, for example, from a set of previously determined 1D bases, although, of course, claimed subject matter is not limited in scope in this respect. A subset of a full n dimensional dictionary may be selected for coding data. In one particular embodiment, although claimed subject matter is not limited in scope in this respect, this may be implemented using a mask to select a subset of a full dictionary. For images, as one example, for a range of numbers of selected bases for a bit rate, a PSNR may, at times, provide improved results in comparison with a full 2D codebook. As described in more detail hereinafter, results with sparse dictionaries, therefore, may have lower computational cost while maintaining data integrity to a high degree.

As is known, a dictionary may play a role in terms of speed for a particular method or process of compression. See, for example, Monro, D. M., “Basis Picking for Matching Pursuits Image Coding”, IEEE International Conference on Image Processing (ICIP 2004), Singapore, September 2004; Yuan Yuan and Monro., D. M., “Improved Matching Pursuits Image Coding”, IEEE International Conference on Acoustics, Speech and Signal Processing ICASSP 2005, Philadelphia, March 2005. However, a dictionary may also play a role in complexity and accuracy, as explained in more detail hereinafter.

For example, if the number of 1D bases is b and the basis width or ‘footprint’ is d=(2wₖ+1), then in 2D there are b² bases. One aspect of a MP process includes repairing or updating inner products in a region of an Atom that has been removed from the data. This may involve calculation of inner products in a d×d=d² region of the image. Even if done separably, one may compute inner products in a first dimension with bases in a 1D region of extent 2d-1 for b bases of width d, at a computational cost of order bd² followed by inner products in a second dimension in a 2D region of extent 2d-1 by 2d-1 for b results of the first stage, using b bases of width d, at a computational cost of order b²d³. In this example, therefore, the second stage is more complex. In higher dimensions, the gain has the potential to be greater since complexity in n dimensions may be proportional to b^{N}d^{N+1}.

In general, a large codebook may give a greater accuracy for a particular number of Atoms selected; however, it may also employ more bits to code an Atom from a larger codebook. Therefore, at a selected bit rate, for example, it may not give the greatest accuracy. As is well-known, reducing the codebook size by half may reduce the bit cost of coding an Atom by 1 bit in the case where all bases are equally likely. More particularly, the cost of coding any of N equally probable symbols is well-known to be log₂ N . Although typically probabilities of occurrence of the bases will, in general, not be equal, a similar effect may occur if the probabilities do not vary widely. Thus, a reduction in the cost of coding may occur as dictionary size is reduced. By trimming an n dimensional codebook, one may accomplish a beneficial rate/distortion trade-off, e.g., a lower distortion at a given rate or a lower bit rate for a given distortion.

In one particular embodiment, a reduced dictionary may be implemented as a mask applied to a full n dimensional dictionary by indicating which bases are to be applied. By referring to this mask, bases from a separable codebook may be selected to perform inner product calculations in a Matching Pursuits (MP) process, or applied to the data in other coding applications. For such an embodiment, while all bases may in some embodiments be considered in a first stage operation of separable computation, not all combinations are used in the second dimension, and fewer still are used in higher dimensions, potentially reducing the number of calculations. This complexity reduction has the potential to make computations feasible, especially for higher dimensional coding tasks that previously may not have been feasible. Likewise, in other embodiments, less than all bases may be considered as well in a first operation, for example. These embodiments are merely intended as illustrative examples; however, many other embodiments are intended and contemplated to be including within the scope of claimed subject matter.

A resulting dictionary may be used on a signal, or data that has been transformed, such as by a wavelet transform. Furthermore, a resulting dictionary may be utilized to code data with an MP process. This process may also be used with other data, including audio, visual, video, multi-dimensional, and/or non-transformed data. Furthermore, a resulting dictionary may be used to code many different types of transformed and/or non-transformed data. Yet further, an embodiment of a method and/or system, for example, within the scope of claimed subject matter, may be utilized to determine resulting dictionaries and/or codebooks for many different types of data coding.

For compression, for example, an MP process may be terminated at some stage and codes for a number of Atoms may stored and/or transmitted by a further coding process. For one embodiment, the further coding process may be a lossless coding process, although claimed subject matter is not limited in scope in this respect. Other embodiments may use other coding techniques, including non-lossless coding techniques, for example.

For example, in one embodiment, an image may be represented as a two-dimensional array of coefficients. A coefficient may represent an intensity levels at a point in such an embodiment, for example. Many images have smooth intensity variations, with the fine details being represented as sharp edges in between the smooth variations. The smooth variations in intensity may be interpreted, therefore, as low frequency components and the sharp variations as high frequency components. Low frequency components (e.g., smooth variations) may comprise gross information for an image, and high frequency components may include information to add detail to the gross information.

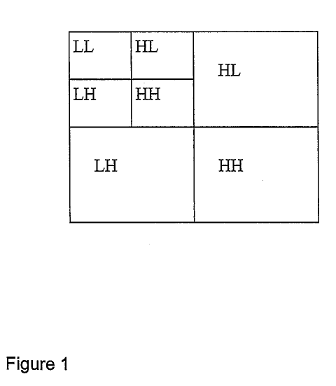

One technique for separating low frequency components from high frequency components may include a Discrete Wavelet Transform (DWT) applied to an image, although this is merely provided as one example and claimed subject matter is not limited in scope to this particular embodiment. Many forms of images might be used, including, for example, still images, whether monochrome or color, which may be called intra frames in video, or the residual frames, whether monochrome or color, after motion prediction in a motion compensated video compression system, Which may be called displaced frame difference images. Again, these are merely examples and claimed subject matter is not limited in scope to these examples. Nonetheless, continuing this discussion, wavelet decomposition may include the application of Finite Impulse Response (FIR) filters to separate image data into sub-sampled frequency bands. The application of the FIR filters may occur in an iterative fashion, for example, as described below in connection with FIG. 1. However, again, this is merely an example embodiment and many other approaches are possible and are intended to be included within the scope of claimed subject matter.

An additional aspect of this particular embodiment, although claimed subject matter is not limited in scope in this respect, is that many methods of coding data involve performing a frequency separating or other transform prior to coding. Transform coding may at times be desirable to apply since after transformation desired information in the data may become concentrated into coefficients that are produced or a subset of those coefficients. One example, again, without limited the scope of claimed subject matter includes the Wavelet Transform, in which an image transformation takes place that reorganizes data into frequency bands, whereby the information in the data becomes concentrated into regions of the transform coefficients according to particular characteristics of the data being transformed. Other transforms may, again, be used. This is merely one convenient example. For example, for Fourier transforms or a Discrete Cosine Transform, often applied to blocks of an image, a coefficient may be associated with a particular range of frequencies. We note that these transforms are themselves associated with specific basis dictionaries. For example, basis dictionaries of a Fourier Transform comprise full-period sine and cosine waveforms and basis dictionaries of a Discrete Cosine Transform comprise full and half period cosines waveforms.

Therefore, continuing with this particular embodiment, regardless of the transform used, once collected into blocks or bands having similar frequency characteristics, it may readily be seen that particular types of information collect into particular regions. One aspect of this particular embodiment, as described in more detail below, performance or results may be improved by employing different codebooks for different regions, such as of a transformed image, for example.

Taking the wavelet transform as an example for this discussion, bands designated HH and LL have no particular orientation of data, and so their most effective types of basis functions may be expected not to have a bias towards horizontal or vertical orientation. This is borne out in practice. However, the LL band is the result of repeated low pass filtering and so is expected to be relatively smooth. A dictionary of low frequency (smooth) bases is therefore also expected to be useful in the LL band. By contrast, the HH band has been high pass filtered in both directions. For this band, of course, information is expected to be localised and spiky, e.g., high frequency. We would, thus, expect HH bands to be represented by relatively high frequency information.

In wavelet decomposition, an image is repeatedly filtered and decimated into high and low spatial frequency bands, alternating between horizontal and vertical directions. The LL band, for example, is the result of low-pass filtering in both directions, HL is,high-pass followed by low-pass, and so on. FIG. 1 is a schematic diagram illustrating an embodiment of a DWT and shows labelling assuming horizontal filtering is done first. In LL and HH sub-bands, there is not an “inherently” preferred spatial orientation of coefficients. However, in HL and LH bands or regions, data is noticeably organized into vertical and horizontal detail respectively. This suggests that different 2D codebooks may be appropriate for different categories of sub-bands or for different regions.

The bands designated HL and LH have been high pass filtered in one direction and low pass filtered in the other. A feature of these bands is that the information displays an orientation in the direction that low pass filtering has been applied. It might therefore be expected that the bases in these bands are very different, expressing the preferred direction of orientation in their composition. It also might be expected that a suitable basis dictionary for the LH band turns out to be suitable for the HL band if it is transposed so that the vertical component of an HL basis becomes the horizontal component of an LH basis, and vice versa. Experimentally, this again turns out to be the case.

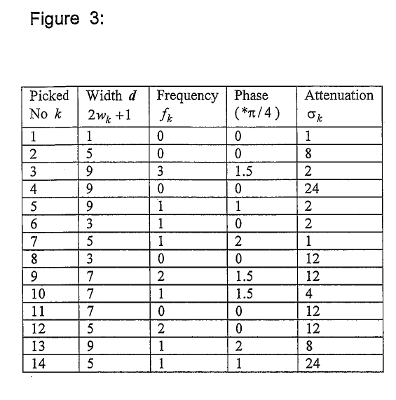

As an example, the table shown in FIG. 3 provides a set of experimentally determined 1D bases from which 2D dictionaries may be formed for image coding. See D. M. Monro and Yuan Yuan, “Bases for low complexity matching pursuits image coding”, IEEE Int. Conf. Image Process., September 2005.

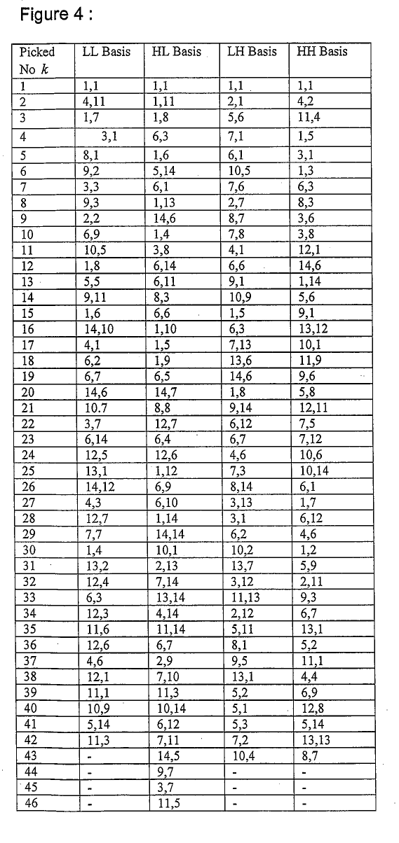

The table in FIG. 3 lists the bases found in the aforementioned article, “Bases for low complexity matching pursuits image coding,” with width d=9. The first 8 bases were recommended for coding residual images and the 14 bases for still images. Likewise, after experimentation, it has been found that combinations of bases listed in the table shown in FIG. 4 form a suitable set for image compression by Matching Pursuits if applied to different classes of sub-bands or regions after wavelet decomposition. The table shown in FIG. 4 is derived from “Subband adaptive dictionaries for Wavelet/Matching Pursuits Image Coding,” by D. M. Monro, Wei Huo and Xiaopeng Wang, to be presented at the IEEE International Conference in Image Processing (ICIP 2006) on 10 Oct. 2006 in Atlanta, Ga. Likewise, expected characteristics, such as those described above, are demonstrated by this data.

In HL and LH codebooks, 15 of 46 bases appear as transposes, compared to 3.8 (e.g., 4) that would be expected by simple probability. This suggests a potential simplification whereby the HL and LH codebooks are the transpose of one another for some embodiments. Also, 7 of the 42 bases in HH are symmetrical compared with 3 that would be expected, which suggests another simplification for some embodiments. These simplifications may reduce the storage employed for dictionaries and may assist in coding of dictionary entries.

In one possible embodiment, therefore, a reduced, band adaptive dictionary may be implemented as a set of masks corresponding to the different categories of coefficients, applied in coding the corresponding regions of the transform coefficients. By referring to the appropriate mask, in some embodiment, for example, a coder may determine which separable bases to be used to perform inner product calculations in a matching pursuits process, or applied to the data in other coding applications. This may imply, for some embodiments, that selected bases may be used in the first stage operation of separable computation with different bands of coefficients, fewer combinations may be used in the second dimension, and fewer still may be used in higher dimensions, potentially reducing the number of calculations. Of course, this is merely one example embodiment and claimed subject matter is not limited in scope in this respect.

As may now be appreciated from the prior description, not every basis is necessarily effective for image coding in a separable basis dictionary for Matching Pursuits (MP), so that a subset of bases may, in some instances, provide improved PSNR while also reducing computational complexity. To provide further background, MP was introduced by Mallat and Zhang for digital audio. See, for example, S. G. Mallat and Z. Zhang, “Matching pursuits with time frequency dictionaries”, IEEE Trans. Signal Processing, vol. 41, pp. 3397-3415, December 1993. Later, Neff and Zakhor applied MP to achieve improved low bit rate video coding for motion compensated residual images within an H.263 video codec. See R. Neff and A. Zakhor “Very low bit rate video coding based on matching pursuits”, IEEE Trans. Circuits Syst. Video Techol., vol. 7, pp. 158-171, February 1997. Likewise, in, for example, Y. Yuan and D. M. Monro, “Improved Matching Pursuits Image Coding”, Proc. IEEE Int. Conf. Acoustics, Speech, Signal Process., Philadelphia, March 2005, gains in fidelity accompanied by reductions in complexity were achieved in MP for coding both still images and motion compensated residuals. These advances came from various approaches, such as pre-transformation by wavelet, an embedded coding scheme for MP, and improved dictionaries found by ‘basis picking,’ see, D. M. Monro, “Basis Picking for Matching Pursuits Image Coding”, IEEE Int. Conf. Image Process. Singapore, October 2004.

For this particular embodiment, to illustrate, a hybrid wavelet/MP codec is employed, although claimed subject matter is not limited in scope in this respect. Again, this is merely provided as an illustrative example. For coding, a multi-scale wavelet decomposition, for example, may be applied using the well-known bi-orthogonal 9/7 filter bank before MP approximation, although, of course, claimed subject matter is not limited in scope in this respect. It has been shown, for example, that 2 scales for CIF (352×288) residuals and 5 scales for D1 (704×576) still images are a good choice, although, again, this is merely an illustrative example and is not intended to limit the scope of claimed subject matter.

Atoms for MP may be found directly on a 2D wavelet coefficient array using a dictionary of 2D bases. In MP coding, a dictionary of basis functions is typically repeatedly searched for an inner product of largest magnitude within a data set. In 2D, however, it is usual to take a dictionary as a set of 1D bases applied separably, as described above, for example. The bases for this particular embodiment comprise an over-complete, non-orthogonal set of Gabor functions, defined by

$${{g}_{k} ( exp ( \frac{- π {t}^{2}}{{σ}_{k}} ) )}^{0.25} cos ( \frac{π {f}_{k} t}{{w}_{k}} + {φ}_{k} )$$

where the dictionary index is k and t ε[−wₖ, . . . wₖ]
Maximum width (‘footprint’) (2wₖ+1) ε [3,5,7,9, . . . ]
Basis frequencies fₖ ε[0,1 . . . , wₖ]
Phase shifts φₖ ε[(0,0.5,1.0,1.5,2)π/4]
Attenuation factors σₖ ε[1,2,4,8,12,16,20,24]

For this particular embodiment, a subset of a full 2D dictionary may be formed. This may be done for this particular embodiment by introducing a mask into the coding process containing a zero value corresponding to a basis that is not used. Beginning with a completely zero mask, for example, a basis may be used in turn to code a training set on its own. The basis giving the highest PSNR at a desired bit rate, for example, may be selected as a first unmasked dictionary entry. With a first basis determined, a test set may be coded with combinations of this first basis with one other basis, and the highest in terms of a defined performance measure, for example, may then be added to the dictionary to become the second unmasked entry for further runs, etc. The process may be repeated until the mask is fully populated. The result is a pruned sparse 2D dictionary of every size from 1 to the maximum. This process is similar to the basis picking method for selecting 1D bases, discussed in D. M. Monro, “Basis Picking for Matching Pursuits Image Coding”, IEEE Int. Conf. Image Process, Singapore, October 2004, although, of course, claimed subject matter is not limited in scope in this respect.

Successive basis masking, of course, may be a computationally intensive process. However, in some embodiments, it may be used to design a masked dictionary and, therefore, may be used in many applications after computation, although claimed subject matter is not limited in scope in this respect. Likewise, for this particular embodiment, four codebooks are sought rather than one. Thus, four masks are used here to select different bases. In this particular embodiment, then a method of coding includes taking into account which sub-band an Atom may occupy, although claimed subject matter is not limited in scope in this respect. In this example, a basis was coded by its “picking order” in the particular sub-band's mask, as in the table shown in FIG. 4. Both coder and decoder, therefore, may refer to a basis by working out which band the center of an atom lay in, from its position. Of course, again this is merely an illustrative embodiment and is not intended to limit the scope of claimed subject matter.

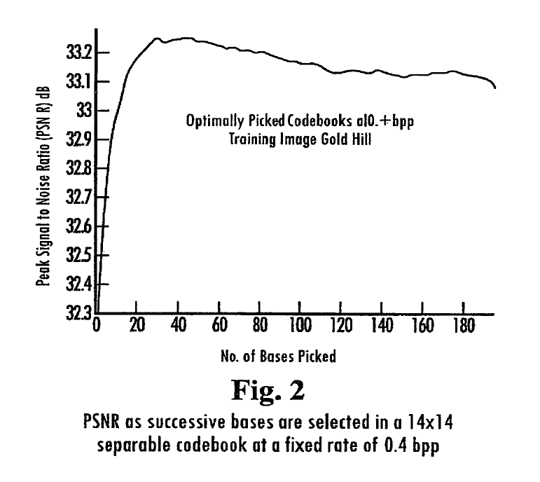

With a 14×14 dictionary used for coding still images, for example, selecting a first basis for the table shown in FIG. 4 was done by experience, as the Dirac or delta function is known to be an effective basis. Finding a second basis involves trying the remaining 195 basis combinations for all four sub-band types which involves 4×194 runs and so on, so that the total number of runs was 76440 in this particular example. The result here is a set of four lists of effective 2D separable bases from the 196 possible combinations. These may be implemented by using 2D masks in an MP coder and decoder. The approach for this embodiment is similar to selecting 1D bases in the previously cited article, “Basis Picking for Matching Pursuits Image Coding,” although, again this is merely an illustrative embodiment and is not intended to limit the scope of claimed subject matter. The previously described embodiment, therefore, is adapted for this embodiment so that, as one mask is being determined, the other three masks are held constant. A trial LL basis giving a peak PSNR at a desired bit rate is ultimately determined. Using this LL mask so found, a similar process may be applied to select a second basis for the HL band, and then with the LH and HH bands. This is repeated to add a third basis for the masks, and can be further repeated until the masks are populated to a desired extent. Of course, claimed subject matter is not limited in scope to picking the highest PSNR. There are countless ways to measure performance, such as visual quality, and SNR or PSNR are simply common examples. However, claimed subject matter is not limited to a particular performance measure. Nonetheless, a typical result using PSNR is given in FIG. 4, in which mask coordinates of separable bases are made up from bases specified in FIG. 3. For still images, the Gold Hill Illuminance (Y) 704×576 image was used as a training set. For this training image, FIG. 2 shows PSNR as 2D bases are selected at 0.4 bpp. For this example, 32 bases appear to provide a peak value.

In this particular embodiment, the picking process was arranged so that one basis was added to a mask in turn. However, once this process produced masks with peak results, another process was applied. Starting with identical codebook sizes, the number of bases was varied for the masks between one basis and a maximum of 40 and peak PSNR was recalculated. This was repeated in the cycle LL-HL-LH-HH until sizes ceased to change. Of course, just as measures other than PSNR may be employed, in another embodiment, for a number of total bases from one to a maximum, for example, one may select a number of bases for the design by comparing peaks that are relatively close and also compare relative complexity. That is, for example, chose a lower PSNR if the reduction in the number of total bases is sufficiently great.

These examples show that subsets of a 2D separable Matching Pursuits Codebook applied to different wavelet sub-bands given low numbers of bases and reduce complexity, although claimed subject matter is not limited to the specifics of these trail examples. Not surprisingly, masks found at low bit rates work better at low bit rates and those found at high bit rates work better at high bit rates. A masked codebook may in some instances, at least, be found which may provide improved overall PSNR performance.

Of course, as may be appreciated, a dictionary may be described implicitly or explicitly. For example, a functional form or a curve or surface may be specified. Thus, supplying parameters rather than pre-computed basis functions may be employed. A dictionary entry, for example, may be communicated as sampled values of a function. Likewise, a dictionary entry may be communicated as parameters from which a function is capable of being computed. Of course, these are merely examples and claimed subject matter is not limited in scope in this respect.

Likewise, in other alternate embodiments, multiple dimensions, such as three spatial dimensions may be employed. In one such example, a 3D MRI Scan, or a 3D map of the temperature of the ocean or of the atmosphere or of any data or measurement describing a volume may be compressed. Likewise, alternately, a third dimension might be time. Likewise, an embodiment may employ four dimensions, such as, for example, a 3D spatial image and time. More than four dimensions may also be possible as, for example, if there is a relationship between temperature and density plus three spatial dimensions plus time. These are merely illustrative examples and many other embodiments of multiple dimensions are included within the scope of claimed subject matter. Likewise, in some embodiments, data may comprise multiple dimensions even if they might or might not be formed separable from lower dimensional bases. In this case a subset of all the possible bases might be used and a multiple dimension mask might be used to indicate which bases are used.

It will, of course, be understood that, although particular embodiments have just been described, the claimed subject matter is not limited in scope to a particular embodiment or implementation. For example, one embodiment may be in hardware, such as implemented to operate on a device or combination of devices, for example, whereas another embodiment may be in software. Likewise, an embodiment may be implemented in firmware, or as any combination of hardware, software, and/or firmware, for example. Likewise, although claimed subject matter is not limited in scope in this respect, one embodiment may comprise one or more articles, such as a storage medium or storage media. This storage media, such as, one or more CD-ROMs and/or disks, for example, may have stored thereon instructions, that when executed by a system, such as a computer system, computing platform, or other system, for example, may result in an embodiment of a method in accordance with claimed subject matter being executed, such as one of the embodiments previously described, for example. As one potential example, a computing platform may include one or more processing units or processors, one or more input/output devices, such as a display, a keyboard and/or a mouse, and/or one or more memories, such as static random access memory, dynamic random access memory, flash memory, and/or a hard drive.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, well known features were omitted and/or simplified so as not to obscure the claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method of successive basis masking for digital data divided into at least four sub bands by applying a wavelet transform, said method comprising:
selecting a first basis for one of said at least four sub bands, a first basis for a second of said at least four sub bands, a first basis for a third of said at least four sub bands, and a first basis for a fourth of said at least four sub bands.

2. The method of claim 1, wherein said bases are selected at a particular bit rate.

3. The method of claim 2, wherein said bases are selected at a particular bit rate to achieve a substantially peak PSNR

4. The method of claim 1, wherein said selecting further comprises selecting successive bases for said sub bands seriatim.

5. The method of claim 4, wherein a successive basis of said successive bases for a sub band are selected at a particular bit rate to achieve a substantially peak PSNR if used for coding with the other selected bases for that sub band.

6. The method of claim 4, wherein said selecting continues until said sub bands are populated to a desired level.

7. The method of claim 6, wherein, after said sub bands are populated identically to a desired level, varying the number of bases for said sub bands masks between one basis and a maximum.

8. The method of claim 7, wherein as the number of bases are varied, recalculating said peak PSNR.

9. The method of claim 8, wherein the number of bases are varied sub band by sub band, from said first to said fourth sub band, until recalculating said peak PSNR does not produce a change in the number of bases for the sub bands.

10. The method of claim 4, wherein said selecting is performed for every number of bases from 1 to a maximum.

11. The method of claim 1, wherein said first sub band comprises a lowest frequency sub band.

12. The method of claim 1, wherein said fourth sub band comprises a highest frequency sub band.

13. The method of claim 1, wherein said sub bands comprise more than four sub bands.

14. An article comprising: a storage medium having stored thereon instructions that, if executed, result in execution of a method of successive basis masking for digital data divided into at least four sub bands by applying a wavelet transform at least as follows:
selecting a first basis for one of said at least four sub bands, a first basis for a second of said at least four sub bands, a first basis for a third of said at least four sub bands, and a first basis for a fourth of said at least four sub bands.

15. The article of claim 14, wherein said instructions, if executed, further result in said bases being selected at a particular bit rate.

16. The article of claim 15, wherein said instructions, if executed, further result in said bases being selected at a particular bit rate to achieve a substantially peak PSNR

17. The article of claim 14, wherein said instructions, if executed, further result in said selecting further comprising selecting successive bases for said sub bands seriatim.

18. The article of claim 17, wherein said instructions, if executed, further result in a successive basis of said successive bases for a sub band being selected at a particular bit rate to achieve a substantially peak PSNR if used for coding with the other selected bases for that sub band.

19. The article of claim 17, wherein said instructions, if executed, further result in said selecting continuing until said sub bands are populated to a desired level.

20. The article of claim 19, wherein said instructions, if executed, further result in, after said sub bands are populated identically to a desired level, varying the number of bases for said sub bands masks between one basis and a maximum.

21. The article of claim 20, wherein said instructions, if executed, further result in as the number of bases being varied and recalculating said peak PSNR.

22. The article of claim 21, wherein said instructions, if executed, further result in the number of bases being varied sub band by sub band, from said first to said fourth sub band, until recalculating said peak PSNR does not produce a change in the number of bases for the sub bands.

23. The article of claim 17, wherein said instructions, if executed, further result in said selecting being performed for every number of bases from 1 to a maximum.

24. The article of claim 14, wherein said instructions, if executed, further result in said first sub band comprising a lowest frequency sub band.

25. The article of claim 14, wherein said instructions, if executed, further result in said fourth sub band comprising a highest frequency sub band.

26. The article of claim 14, wherein said instructions, if executed, further result in said sub bands comprising more than four sub bands.

27. An apparatus comprising:
a computing platform;
said computing platform being adapted to successively basis mask digital data if said digital data has been transformed into at least four sub bands;
said computing platform being further adapted to select a first basis for one of said at least four sub bands, a first basis for a second of said at least four sub bands, a first basis for a third of said at least four sub bands, and a first basis for a fourth of said at least four sub bands.

28. The apparatus of claim 27, wherein said computing platform is further adapted to select said bases at a particular bit rate.

29. The apparatus of claim 28, wherein said computing platform is further adapted to said bases select at a particular bit rate to achieve a substantially peak PSNR

30. The apparatus of claim 27, wherein said computing platform is further adapted to select successive bases for said sub bands seriatim.

31. The apparatus of claim 30, wherein said computing platform is further adapted to select, if used for coding with the other selected bases for that sub band, said successive bases for a sub band at a particular bit rate to achieve a substantially peak PSNR

32. The apparatus of claim 30, wherein said computing platform is further adapted to select said successive bases continuing until said sub bands are populated to a desired level.

33. The apparatus of claim 32, wherein said computing platform is further adapted to, after said sub bands are populated identically to a desired level, vary the number of bases for said sub bands masks between one basis and a maximum.

34. The apparatus of claim 33, wherein said computing platform is further adapted to, as the number of bases are varied, recalculate said peak PSNR.

35. The apparatus of claim 34, wherein said computing platform is further adapted to vary the number of bases sub band by sub band, from said first to said fourth sub band, until recalculating said peak PSNR does not produce a change in the number of bases for the sub bands.

36. The apparatus of claim 30, wherein said computing platform is further adapted to perform bases selection for every number of bases from 1 to a maximum.
